(19) United States
(12) Patent Application Publication
(10) Pub. No.: US 2018/0245297 A1
(43) Pub. Date: Aug. 30, 2018

(54) Highway safety protective fence and method for manufacturing the same

(71) Applicant: Xinqiao He, Shenzhen (CN)

(72) Inventor: Xinqiao He, Shenzhen (CN)

(21) Appl. No.: 15/968,756

(22) Filed: May 2, 2018

(51) Int. Cl. E01F 15/04; C21D 9/00; B32B 15/06; B32B 15/18; C08L 21/00; C08J 9/00

(52) U.S. Cl. CPC E01F 15/0407; E01F 15/0453; C21D 9/0068; C21D 1/58; B32B 15/18; C08L 21/00; C08J 9/00; B32B 15/06

(57) ABSTRACT

A highway safety protective fence includes a processed steel guardrail board and a protective sleeve, wherein the protective sleeve is sleeved to an outer surface of the processed steel guardrail board. Furthermore, a method for manufacturing the highway safety protective fence includes steps of: conveying an original steel guardrail board to a quenching furnace through a temperature withstanding ceramic stick, quenching, conveying to a constant temperature furnace, staying, conveying to a quenching oil solution tank, cooling in sequence and obtaining a processed steel guardrail board; conveying the processed steel guardrail board to a rubber coating machine through a conveying belt, and packaging the processed steel guardrail board with the protective sleeve to obtain the highway safety protective fence. In the highway safety protective fence provided by the present invention, the steel guardrail board is quenched to greatly increase the safety factor.

### BACKGROUND OF THE PRESENT INVENTION

### Field of Invention

The present invention relates to the technical field of traffic safety, and more particularly to a highway safety protective fence and a method for manufacturing the highway safety protective fence.

### Description of Related Arts

The existing highway protective fence is mainly manufacturing through bending the metal material. It is a continuous structure which comprises multiple corrugated steel guardrail boards jointed with each other and a main support for supporting the corrugated steel guardrail boards. When a vehicle collides with the protective fence, because the corrugated steel guardrail boards have good crashworthiness and energy absorption, the vehicle can be effectively avoided collision and damage, meanwhile, the passengers are protected. The fence is divided into two categories: a double corrugated shaped fence (with a length of 4320 MM, a width of 310 MM, a wave depth of 85 MM and a board width of 3-4 MM) and a triple corrugated shaped fence (with a length of 4320 MM, a width of 506 MM, a wave depth of 85 MM and a board width of 3-4 MM). It is proved that the traditional highway protective fence is still very easy to be crashed by cars, and especially in the process of collision, sparks will cause serious damage to the cars and the burning of the cars will cause serious damage to the passengers. Most of the traffic accidents are caused by the collision of highway protective fences.

Therefore, it is highly practical to design and produce a beautiful, durable, weather resistant, non-deformable, recycled and reused new modified rubber or EVA material to package the existing protective fence for reinforcing the protective fence.

### SUMMARY OF THE PRESENT INVENTION

Aiming at deficiencies mentioned above, the present invention provides a highway safety protective fence which is able to effectively increase the safety factor and a method for manufacturing the highway safety protective fence.

To achieve the above object, the present invention provides a highway safety protective fence which comprises a processed steel guardrail board and a protective sleeve, wherein the protective sleeve is sleeved to an outer surface of the processed steel guardrail board; the processed steel guardrail board is prepared through conveying an original steel guardrail board to a quenching furnace through a temperature withstanding ceramic stick, quenching, conveying to a constant temperature furnace, staying, conveying to a quenching oil solution tank, and cooling.

Preferably, the protective sleeve is a modified vulcanized rubber protective sleeve which comprises components of vulcanized rubber, nano-zinc oxide, nanosilica and a modifier with a weight ratio of (96-100):(0.1-0.2):(1.2-1.4):(0.4-0.8).

More preferably, the vulcanized rubber comprises a raw rubber material, alkali free glass fiber powders with a particle size of 800 meshes, sulfur, a vulcanized accelerant, phenolic resin powders and hard carbon black with a weight ratio of 78:10:6:1:2:1.

Preferably, the protective sleeve is made from a foamed EVA (ethylene-vinyl acetate copolymer) material.

Preferably, the processed steel guardrail fence has a double or triple corrugated shape.

Also, the present invention provides a method for manufacturing a highway safety protective fence, which comprises steps of:

(S1) processing an original steel guardrail board which comprises heating, quenching, standing at a constant temperature and cooling in sequence in a quenching furnace;

(S2) selecting a protective sleeve, wherein the protective sleeve is made from modified vulcanized rubber or a foamed EVA (ethylene-vinyl acetate copolymer) material; and

(S3) fixing the protective sleeve which comprises after cooling the processed steel guardrail board, conveying the steel guardrail board to a rubber coating machine through a conveying belt, and then packaging the steel guardrail board with the protective sleeve.

Preferably, the step (S1) of processing the original steel guardrail board specifically comprises:

(S11) preparing the quenching furnace based on high-frequency rapid heating principle;

(S12) conveying the original steel guardrail board to the quenching furnace through a temperature withstanding ceramic stick, and quenching for 180 seconds;

(S13) conveying the quenched steel guardrail board to a constant temperature furnace and staying for 90 seconds; and

(S14) finally conveying the steel guardrail board to a quenching oil solution tank and staying for 15 seconds.

Preferably, in the step (S2), the protective sleeve is a modified vulcanized rubber protective sleeve which comprises components of vulcanized rubber, nano-zinc oxide, nanosilica and a modifier with a weight ratio of (96-100):(0.1-0.2):(1.2-1.4):(0.4-0.8).

More preferably, in the step (S2), the modified vulcanized rubber protective sleeve is preparing through putting the vulcanized rubber into a blending furnace and heating to 200° C.; and then adding the nano-zinc oxide and stirring for 10 minutes; and then adding the nanosilica and stirring for 5 minutes; and then adding the modifier, stirring for 30 minutes and obtaining a mixture; and then putting the mixture into a four-roll calender, and shaping.

More preferably, the vulcanized rubber comprises a raw rubber material, alkali free glass fiber powders with a particle size of 800 meshes, sulfur, a vulcanized accelerant, phenolic resin powders and hard carbon black with a weight ratio of 78:10:6:1:2:1.

Beneficially effects of the present invention are as follows.

Compared with the prior art, the highway safety protective fence provided by the present invention is preparing through quenching the existing steel guardrail board, so that the strength, toughness and fatigue strength of the protective fence are increased. The purpose of quenching is to transform undercooled austenite into Martensite or Bainite tissue through Martensite or Bainite transformation, and then cooperate with tempering at different temperatures for significantly increasing the strength, hardness, wear resistance, fatigue strength and toughness of steel, so as to meet a variety of different requirements. Also, some special physical and chemical properties such as ferromagnetism and corrosion resistance of some special steels are met by quenching. The protective sleeve is able to provide cushioning and anti-collision effects. When a car crashes, it is not only difficult to crash the guardrail, but also enhances the safety and protection of the passengers; and moreover, no sparks are produced which prevents collision burning problems. Therefore, the safety factor is greatly increased.

### BRIEF DESCRIPTION OF THE DRAWINGS

FIG. 1 is a flow chart of a method for manufacturing a highway safety protective fence provided by the present invention.

FIG. 2 is a schematic view of a highway safety protective fence provided by the present invention.

In the drawings, 1: processed steel guardrail board; 2: protective sleeve.

### DETAILED DESCRIPTION OF THE PREFERRED EMBODIMENT

The present invention is further explained with accompanying drawings in detail as follows.

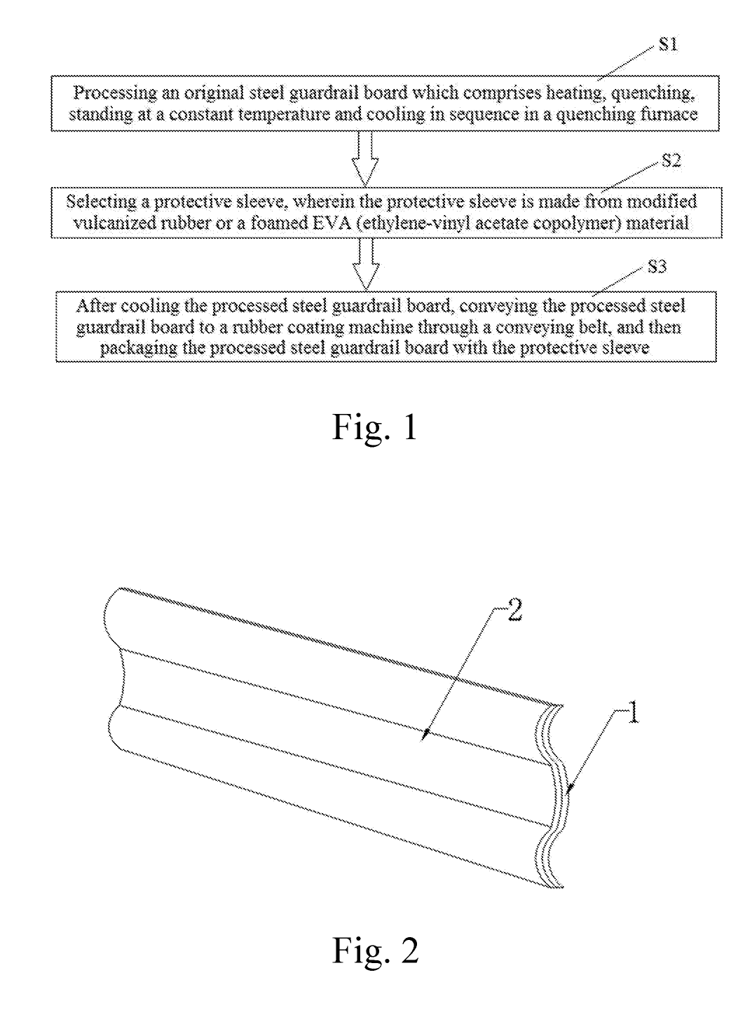

Referring to FIG. 1, a method for manufacturing a highway safety protective fence is illustrated, which comprises steps of:

(S1) processing an original steel guardrail board which comprises heating, quenching, standing at a constant temperature and cooling the original steel guardrail board in sequence in a quenching furnace;

(S2) selecting a protective sleeve, wherein the protective sleeve is made from modified vulcanized rubber or a foamed EVA (ethylene-vinyl acetate copolymer) material; and

(S3) fixing the protective sleeve which comprises after cooling the processed steel guardrail board, conveying the processed steel guardrail board to a rubber coating machine through a conveying belt, and packaging the protective sleeve on the processed steel guardrail board.

Compared with the prior art, the highway safety protective fence provided by the present invention is manufacturing through quenching the existing steel guardrail board, so that the strength, toughness and fatigue strength of the protective fence are increased. The purpose of quenching is to transform undercooled austenite into Martensite or Bainite tissue through Martensite or Bainite transformation, and then cooperate with tempering at different temperatures for significantly increasing the strength, hardness, wear resistance, fatigue strength and toughness of steel, so as to meet a variety of different requirements. Also, some special physical and chemical properties such as ferromagnetism and corrosion resistance of some special steels are met by quenching. The protective sleeve is able to provide cushioning and anti-collision effects. When a car crashes, it is not only difficult to crash the guardrail, but also enhances the safety and protection of the passengers; and moreover, no sparks are produced which prevents collision burning problems. Therefore, the safety factor is greatly increased.

According to the preferred embodiment of the present invention, the step (S1) of processing the original steel guardrail board specifically comprises:

(S11) preparing the quenching furnace based on high-frequency rapid heating principle;

(S12) conveying the original steel guardrail board to the quenching furnace through a temperature withstanding ceramic stick, and quenching for 180 seconds;

(S13) conveying the quenched steel guardrail board to a constant temperature furnace and staying for 90 seconds; and

(S14) finally conveying the steel guardrail board to a quenching oil solution tank and staying for 15 seconds.

According to the preferred embodiment of the present invention, in the step (S2), the protective sleeve is a modified vulcanized rubber protective sleeve which comprises components of vulcanized rubber, nano-zinc oxide, nanosilica and a modifier with a weight ratio of (96-100 0.1-0.2):(1.2-1.4):(0.4-0.8).

According to the preferred embodiment of the present invention, in the step (S2), the modified vulcanized rubber protective sleeve is preparing through putting the vulcanized rubber into a blending furnace and heating to 200° C.; and then adding the nano-zinc oxide and stirring for 10 minutes; and then adding the nanosilica and stirring for 5 minutes; and then adding the modifier, stirring for 30 minutes and obtaining a mixture; and then putting the mixture into a four-roll calender, and shaping.

According to the preferred embodiment of the present invention, the vulcanized rubber comprises a raw rubber material, alkali free glass fiber powders with a particle size of 800 meshes, sulfur, a vulcanized accelerant, phenolic resin powders and hard carbon black with a weight ratio of 78:10:6:1:2:1.

Also, the present invention provides a highway safety protective fence, referring to FIG. 2, which comprises a processed steel guardrail board 1 and a protective sleeve 2, wherein the protective sleeve 2 is sleeved to an outer surface of the processed steel guardrail board 1. In addition, an original steel guardrail board is conveyed to a quenching furnace through a temperature withstanding ceramic stick for being quenched, and then is conveyed to a constant temperature furnace for staying, and then is conveying to a quenching oil solution tank for being cooled, and then conveyed to a rubber coating machine through a conveying belt; and then a modified vulcanized rubber or foamed EVA protective sleeve is sleeved to the processed steel guardrail board 1, thus obtaining the highway safety protective fence.

According to the preferred embodiment of the present invention, the protective sleeve 2 is the modified vulcanized rubber protective sleeve, which comprises components of vulcanized rubber, nano-zinc oxide, nanosilica and a modifier with a weight ratio of (96-100):(0.1-0.2):(1.2-1.4):(0.4-0.8); and preferably, 98:0.1:1.3:0.6

According to the preferred embodiment of the present invention, the vulcanized rubber comprises a rubber raw material, alkali free glass fiber powders with a particle size of 800 meshes, sulfur, vulcanized accelerant, phenolic resin powders and hard carbon black with a weight ratio of 78:10:6:1:2:1.

According to the preferred embodiment of the present invention, the protective sleeve 2 is made from a foamed EVA (ethylene-vinyl acetate copolymer) material.

According to the preferred embodiment of the present invention, the processed steel guardrail fence has a double or triple corrugated shape.

The above disclosure is only a few specific embodiments of the present invention, but the present invention is not limited to the above disclosure. Any changes that can be considered by those skilled in the art should fall within the protective scope of the present invention.

What is claimed is:

1. A highway safety protective fence, comprising: a processed steel guardrail board and a protective sleeve, wherein the protective sleeve is sleeved to an outer surface of the processed steel guardrail board; the processed steel guardrail board is prepared through conveying an original steel guardrail board to a quenching furnace through a temperature withstanding ceramic stick, quenching, conveying to a constant temperature furnace, staying, conveying to a quenching oil solution tank, and cooling.

2. The highway safety protective fence, as recited in claim 1, wherein the protective sleeve is a modified vulcanized rubber protective sleeve which comprises components of vulcanized rubber, nano-zinc oxide, nanosilica and a modifier with a weight ratio of (96-100):(0.1-0.2):(1.2-1.4):(0.4-0.8).

3. The highway safety protective fence, as recited in claim 2, wherein the vulcanized rubber comprises a raw rubber material, alkali free glass fiber powders with a particle size of 800 meshes, sulfur, a vulcanized accelerant, phenolic resin powders and hard carbon black with a weight ratio of 78:10:6:1:2:1.

4. The highway safety protective fence, as recited in claim 1, wherein the protective sleeve is made from a foamed EVA (ethylene-vinyl acetate copolymer) material.

5. The highway safety protective fence, as recited in claim 1, wherein the processed steel guardrail fence has a double or triple corrugated shape.

6. A method for manufacturing a highway safety protective fence, comprising steps of:
(S1) processing an original steel guardrail board which comprises heating, quenching, standing at a constant temperature and cooling in sequence in a quenching furnace;
(S2) selecting a protective sleeve, wherein the protective sleeve is made from modified vulcanized rubber or a foamed EVA (ethylene-vinyl acetate copolymer) material; and
(S3) fixing the protective sleeve which comprises after cooling the processed steel guardrail board, conveying the processed steel guardrail board to a rubber coating machine through a conveying belt, and then packaging the processed steel guardrail board with the protective sleeve.

7. The method, as recited in claim 6, wherein the step (S1) of processing the original steel guardrail board specifically comprises steps of:
(S11) preparing the quenching furnace based on high-frequency rapid heating principle;
(S12) conveying the original steel guardrail board to the quenching furnace through a temperature withstanding ceramic stick, and quenching for 180 seconds;
(S13) conveying the quenched steel guardrail board to a constant temperature furnace and staying for 90 seconds; and
(S14) finally conveying the steel guardrail board to a quenching oil solution tank and staying for 15 seconds.

8. The method, as recited in claim 6, wherein in the step (S2), the protective sleeve is a modified vulcanized rubber protective sleeve which comprises components of vulcanized rubber, nano-zinc oxide, nanosilica and a modifier with a weight ratio of (96-100):(0.1-0.2):(1.2-1.4):(0.4-0.8).

9. The method, as recited in claim 8, wherein in the step (S2), the modified vulcanized rubber protective sleeve is preparing through putting the vulcanized rubber into a blending furnace and heating to 200° C.; and then adding the nano-zinc oxide and stirring for 10 minutes; and then adding the nanosilica and stirring for 5 minutes; and then adding the modifier, stirring for 30 minutes and obtaining a mixture; and then putting the mixture into a four-roll calender, and shaping.

10. The method, as recited in claim 8, wherein the vulcanized rubber comprises a raw rubber material, alkali free glass fiber powders with a particle size of 800 meshes, sulfur, a vulcanized accelerant, phenolic resin powders and hard carbon black with a weight ratio of 78:10:6:1:2:1.
